(19) United States
(12) Patent Application Publication
(10) Pub. No.: US 2005/0157496 A1
(43) Pub. Date: Jul. 21, 2005

(54) Desk lamp with rotary switch

(76) Inventor: Chun-I Chen, Taipei (TW)

Correspondence Address: Wisam Enterprises Co., Ltd., P.O. Box No. 6-57, Junghe, Taipei, 235, TW

(21) Appl. No.: 10/759,147

(22) Filed: Jan. 20, 2004

(51) Int. Cl. F21V 13/00

(52) U.S. Cl. 362/243

(57) ABSTRACT

A desk lamp with rotary switch, characterized in that a control rotary table and a rotary switch are configured on a base of the lamp. The rotary switch enables a power supply and lightbulbs to constitute a circuit loop. According to the aforesaid structure, the desk lamp utilizes the control rotary table to control turning on and turning off of the lightbulbs. Thus, the desk lamp having a unique design enhances eye appeal and fascination, as well as achieving efficacy of endowing a consumer with a novel feeling toward the desk lamp and thus producing a desire to purchase the desk lamp.

### BACKGROUND OF THE INVENTION

(a) Field of the Invention

The present invention relates to a structure of a desk lamp with rotary switch, and more particularly to the desk lamp that enhances eye appeal and fascination, as well as achieving efficacy of endowing a consumer with a novel feeling toward the desk lamp and thus producing a desire to purchase the desk lamp.

(b) Description of the Prior Art

Accordingly, a switch used by a conventional desk lamp generally relies on employment of external means to control an electric contact for opening or closing of an electric circuit. Common switches in usage include a push button switch, a cutover switch, a rotary switch, and so on, albeit having structures which are largely identical with minor differences. Furthermore, different style desk lamps merely differ in alteration of exterior, and a power switch of the desk lamp has never undergone any innovative design changes in applicable usage of such. Hence, because of lack in any characteristic innovation, desire of a consumer to purchase such desk lamps naturally declines considerably, and therefore there is a need for research and development to improve upon the structure of the conventional desk lamp.

### SUMMARY OF THE INVENTION

In light of aforementioned shortcomings of a conventional desk lamp, the inventor of the present invention, having accumulated years of professional experience engaged in related art, has undertaken attentive and circumspect research to finally design a completely new desk lamp with rotary switch.

A primary objective of the present invention is to provide the desk lamp that enhances fascination in usage, as well as achieving efficacy of endowing a consumer with a novel feeling toward the desk lamp and thus producing a desire to purchase the desk lamp.

To achieve aforesaid objective, the desk lamp with rotary witch of the present invention primarily comprises a configuration fitted in a base of the desk lamp having functionality to control turning on and turning off of lightbulbs, and characterized in that two lampshades are separately configured on extremities of the desk lamp, with lightbulbs being separately fitted within the two lampshades. A control rotary table is configured on the base of the desk lamp, and an inner mating gear is formed on an inner surface of the control rotary table. A gear is further assembled on the base within the control rotary table, and configured so as to mesh with the inner mating gear. An axis of the gear is mutually connected to a four-section type rotary switch; therewith the rotary switch enables a power supply and two light bulbs to constitute a circuit loop therefrom.

In respect of the aforementioned structure, utilization of left or right rotation of the rotary switch thereby separately controls turning on or turning off of the lighbulbs therewith. Thus enhancing fascination in the desk lamp, as well as achieving efficacy of endowing a consumer with a novel feeling toward the desk lamp and thus producing a desire to purchase the desk lamp.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded elevational view according to the present invention.

FIG. 2 shows a top view of a rotary structure according to the present invention.

FIG. 3 shows an elevational view of the rotary structure according to the present invention.

FIG. 4 shows a schematic view of an assemblage according to the present invention.

### DETAILED DESCRIPTION OF THE PREFERRED EMBODIMENTS

Structure, installation and characteristics of preferred, feasible embodiments of the present invention are disclosed in the following detailed description in conjunction with accompanying drawings:

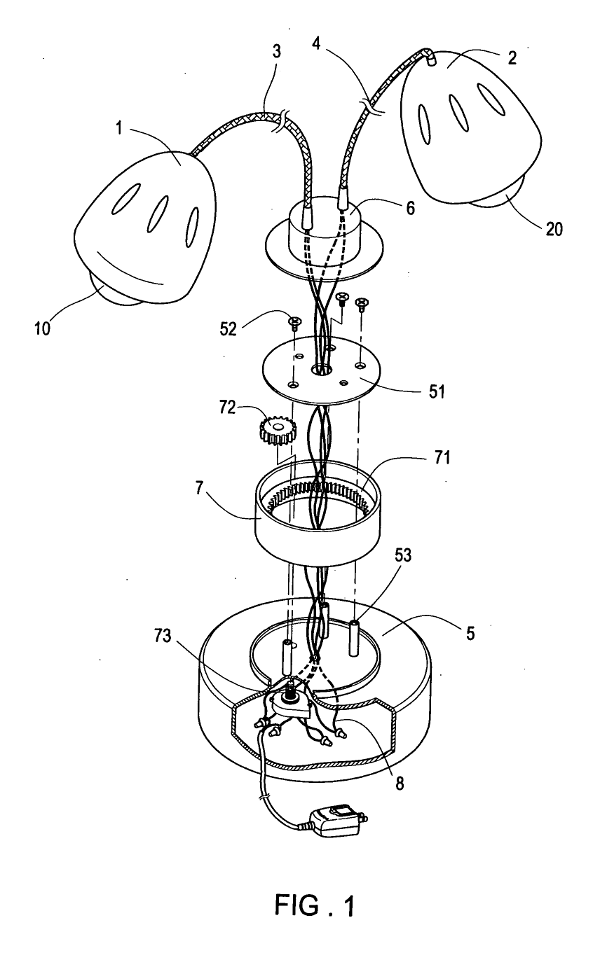

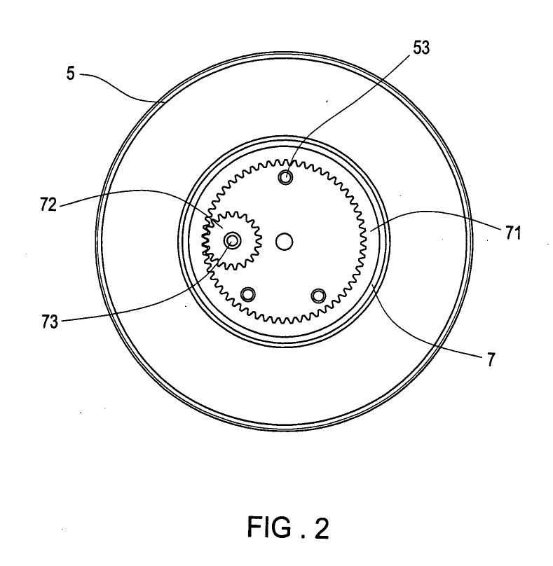

Referring to FIGS. 1 and 2, which show a desk lamp with rotary switch of the present invention primarily structured to comprise a left lampshade 1, a right lampshade 2, a left support stand 3, a right support stand 4, a base 5 and a lamp holder 6. The left lampshade 1 and the right lampshade 2 are separately configured on extremities of the left support stand 3 and the right support stand 4 respectively. Lightbulbs 10 and 20 are separately fitted within the left lampshade 1 and the right lampshade 2 respectively. The left support stand 3 and the right support stand 4 are mounted onto the lamp holder 6, and the lamp holder 6 is mounted onto the base 5 thereof. The present invention is characterized in that:

A freely rotatable control rotary table 7 is configured between the base 5 and the lamp holder 6, and an inner mating gear 71 is formed on an inner surface of the control rotary table 7. A gear 72 is further assembled on the base 5 within the control rotary table 7, and configured so as to mesh with the inner mating gear 71. A fixing plate 51 is placed atop the inner mating gear 71 and the gear 72, and screws 52 are utilized to screw down the fixing plate 51 onto fixing posts 53 configured on the base 5 thereof. An axis of the gear 72 is mutually connected to a rotating shaft of a rotary switch 73, and the rotary switch 73 is connected to a power cord 8. The rotary switch 73 is configured to be of a four-section type switch, and based on such a structural configuration; a power supply and the lightbulbs 10 and 20 separately constitute a circuit loop.

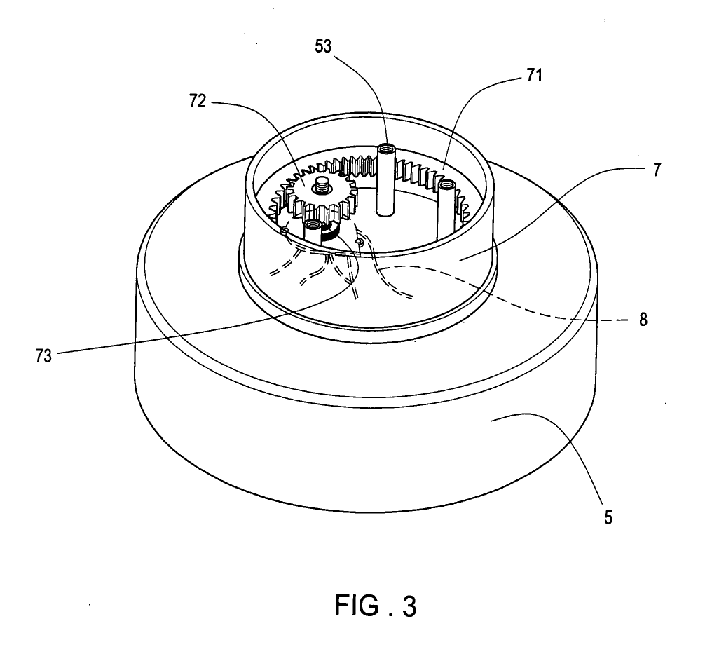

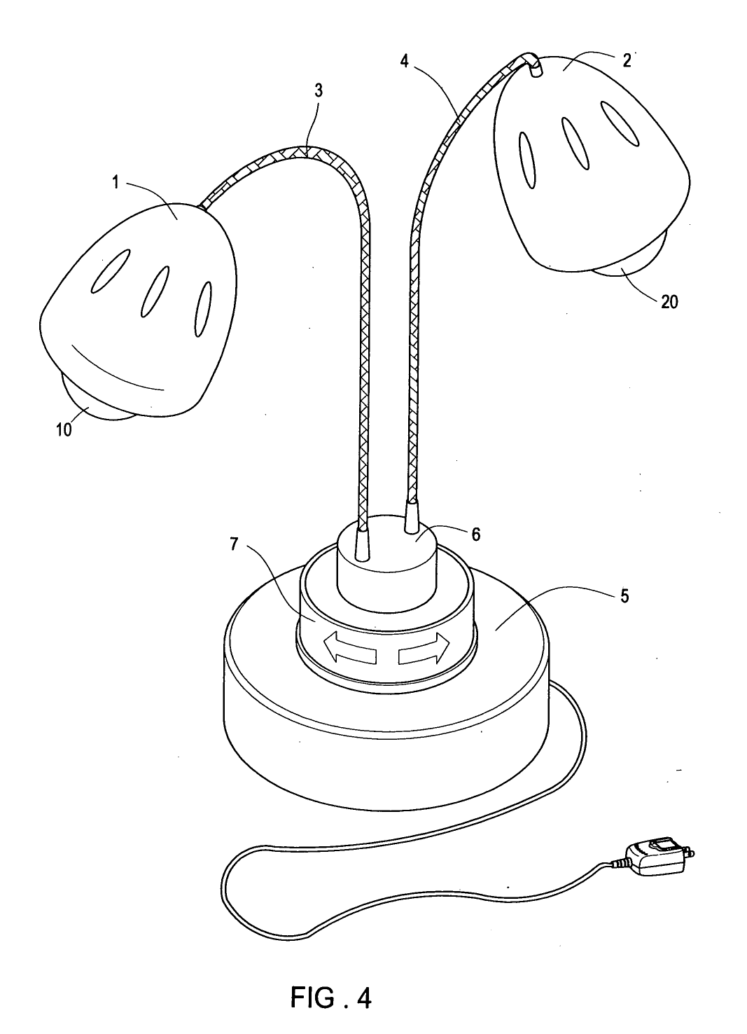

According to aforementioned structure, and referring to FIGS. 3 and 4, upon the control rotary table 7 rotating left or right, the inner gear 71 on the inner surface of the control rotary table 7 simultaneously drives the gear 72, which thereupon rotates within the control rotary table 7, and through utilization of the rotating gear 72 the rotating shaft of the rotary switch 73 turns thereof. An electrical contact within the rotary switch 73 is made to form a closed circuit with the power cord 8 and thereby flow of an electric circuit to either the lightbulb 10 or the lightbulb 20 is controlled therewith, and allows the lightbulbs 10 and 20 to emit light or be turned off.

In respect of foresaid, the structure of the desk lamp with rotary switch according to the present invention differs greatly in comparison to configuration of a conventional desk lamp switch and mode of usage. The structure of the rotary switch structure for the desk lamp according to the present invention bestows the desk lamp with fascination, and averts feeling of a bulginess resulting from the conventional switch configured atop the desk lamp thereof.

In conclusion, the desk lamp with rotary switch of the present invention assuredly enhances eye appeal and fascination of the desk lamp, as well as achieving efficacy of endowing a consumer with a novel feeling toward the desk lamp and thus producing a desire to purchase the desk lamp. The present invention is further provided with practicability and advancement. Accordingly, the inventor of the present invention hereby proposes an application for a new patent as disclosed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A desk lamp with rotary switch, primarily structured to comprise a left lampshade, a right lampshade, a left support stand, a right support stand, a base and a lamp holder; whereby the left lampshade and the right lampshade are separately configured on extremities of the left support stand and the right support stand respectively, and lightbulbs are separately fitted within the left lampshade and the right lampshade respectively; the left support stand and the right support stand are mounted onto the lamp holder, and the lamp holder is mounted onto the base thereof; and is characterized in that:
a freely rotatable control rotary table is configured between the base and the lamp holder, and an inner mating gear is formed on an inner surface of the control rotary table thereof; a gear is further assembled on the base within the control rotary table, and configured so as to mesh with the inner mating gear; a fixing plate is placed atop the inner mating gear and the gear, and screws are utilized to screw down the fixing plate onto fixing posts configured on the base thereof; an axis of the gear is mutually connected to a rotating shaft of a rotary switch, and the rotary switch is connected to a power cord, which in conjunction with the lightbulbs constitutes a circuit loop therefrom.

2. The desk lamp with rotary switch according to claim 1, wherein the rotary switch is configured to be of a four-section type rotary switch.
